(19) United States
(12) Patent Application Publication
(10) Pub. No.: US 2014/0106323 A1
(43) Pub. Date: Apr. 17, 2014

(54) REPRESENTATIONS OF PHYSIOLOGICAL STRUCTURES FOR TREATMENT SIMULATION

(71) Applicants: Mark D. Kraft, Las Vegas, NV (US); Robert E. Wright, Denver, CO (US)

(72) Inventors: Mark D. Kraft, Las Vegas, NV (US); Robert E. Wright, Denver, CO (US)

(21) Appl. No.: 13/943,663

(22) Filed: Jul. 16, 2013

Related U.S. Application Data
(60) Provisional application No. 61/672,277, filed on Jul. 16, 2012.

(51) Int. Cl. G09B 23/28

(52) U.S. Cl. CPC G09B 23/28
USPC 434/262

(57) ABSTRACT

Representations of physiological structures for thermal treatment simulation. Training operators of the treatment devices by physically illustrating thermal profiles on organs, tissue, and nerves in real time may advantageously provide an understanding of heating and/or cooling effects. An experimenter may witness the thermal effects of lesion creation (e.g., RF lesion creation) rather than just monitoring a thermocouple temperature and assuming end-organ/tissue/nerve effects.

### CROSS-REFERENCE TO RELATED APPLICATIONS

This application claims priority benefit of U.S. Provisional Patent App. No. 61/672,277, filed Jul. 16, 2012, which is incorporated herein by reference in its entirety.

### SUMMARY

Thermocouples connected to treatment devices such as needles or cannulas generally indicate the temperature of the tip or the cannula, but are generally not indicative of the heating of the end organ, tissue, or nerves. Example treatment devices are described in U.S. Patent Application No. 13/101,009, filed on May 4, 2011, entitled “Systems and Methods for Tissue Ablation,” published as U.S. Patent Publication No. 2011/0288540 on Nov. 24, 2011, which is incorporated herein by reference in its entirety. Other devices that provide heat and/or cooling (e.g., cryogenically) are also possible.

Certain embodiments described herein can be used as representations of physiological structures for treatment simulation. Training operators of the treatment devices by physically illustrating thermal profiles on organs, tissue, and nerves in real time may advantageously provide an understanding of heating and/or cooling effects. An experimenter, for example adjusting parameters of a treatment device or testing new treatment devices, may advantageously witness the thermal effects of lesion creation (e.g., RF lesion creation) rather than just monitoring a thermocouple temperature and assuming end-organ/tissue/nerve effects.

### BRIEF DESCRIPTION OF THE DRAWINGS

FIG. 1 illustrates an example representation of a physiological structure, the transverse process, which can be used to gauge the application of heat and/or cold.

FIGS. 2a and 2b illustrate example representations of a physiological structure, a plurality of nerves, in gel (e.g., Agar), although other media is also possible, which can be used to gauge the application of heat and/or cold.

FIGS. 3a and 3b illustrate example representations of a physiological structure, two nerves, in gel (e.g., Agar), although other media is also possible, which can be used to gauge the application of heat and/or cold.

FIG. 4 illustrates an example representation of a physiological structure (e.g., a spool which may represent, for example, bone) in gel (e.g., Agar), although other media is also possible, which can be used to gauge the application of heat and/or cold.

FIGS. 5a-5c illustrate an example representation of a physiological structure, a transverse process, in gel (e.g., Agar), although other media is also possible, which can be used to gauge the application of heat and/or cold.

FIG. 5d shows the transverse process prior to being covered with the heat-sensitive material.

FIG. 6a illustrates an example representation, beads, of a physiological structure in gel (e.g., Agar), although other media is also possible, which can be used to gauge the application of heat and/or cold.

FIG. 6b shows the structure of FIG. 6a being held as a representation of the general size.

FIGS. 6c and 6d illustrate the physiological structure of FIGS. 6a and 6b the application of heat and/or cold.

FIGS. 7a and 7b illustrate different sides of a bottle of an example source of media, agar, suitable for use in the representations of physiological structures described herein.

### DETAILED DESCRIPTION

### Measurement

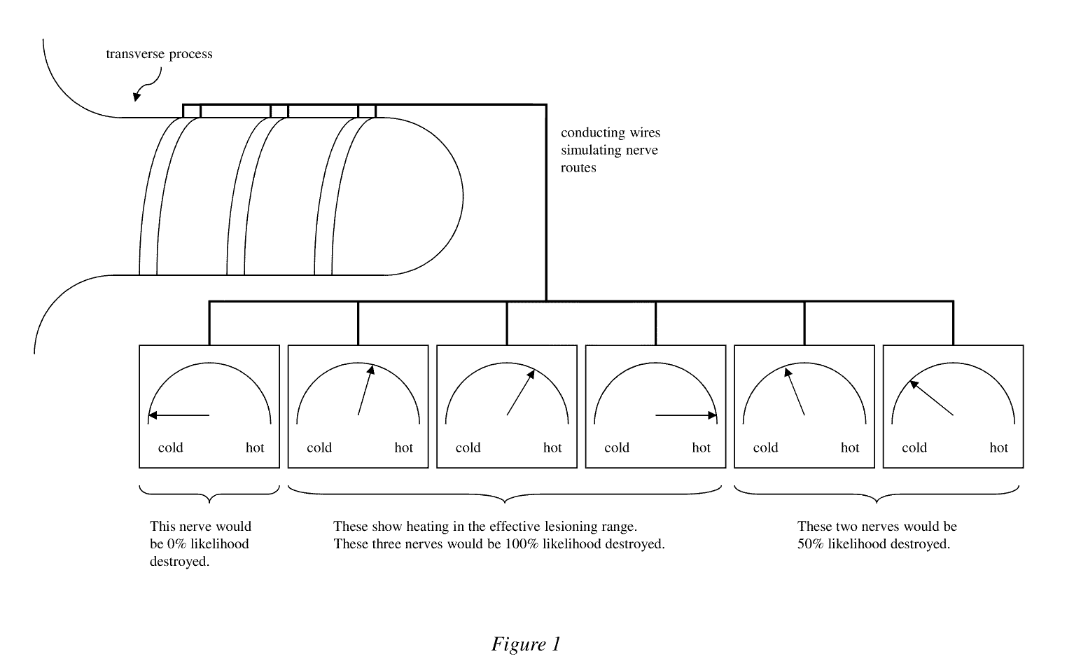

FIG. 1 illustrates an example representation of a physiological structure, the transverse process, which can be used to gauge the application of heat and/or cold. The structure includes a plurality of conducting wires each simulating a nerve route and connected to a meter (e.g., thermometer). Other anatomical routing of nerves is also possible. The structure may be in an ambient environment or immersed in a substance such as water, agar, egg white, etc.

In a heating application such as radiofrequency (RF), advancement of the needles on the meters from “cold” to “hot” indicate that more heat is being applied to that wire or would be applied to that nerve. Certain points on the gauges may indicate when thermal destruction or ablation of the nerve could be expected. In the example illustrated in FIG. 1, from left to right: the first gauge points to cold, indicating that this nerve would be 0% likelihood destroyed; the next three gauges point to being more hot than cold, indicating that (1) heating is in the effective lesioning range and/or (2) these three nerves would be 100% likelihood destroyed; and the last two gauges point to being somewhat more than cold, indicating that these two nerves would be between 0% and 100% (e.g., about 50%) likelihood destroyed.

In a cooling application such as cryogenics, advancement of the needles on the meters from “hot” to “cold” indicate that more cooling is being applied to that wire or would be applied to that nerve. Certain points on the gauges may indicate when thermal destruction or freezing of the nerve could be expected.

Could have needle wires showing the nerve optional, possible pathways and determining, for training purposes, the proximity of heating element to the simulated nerves.

### Destructive Testing

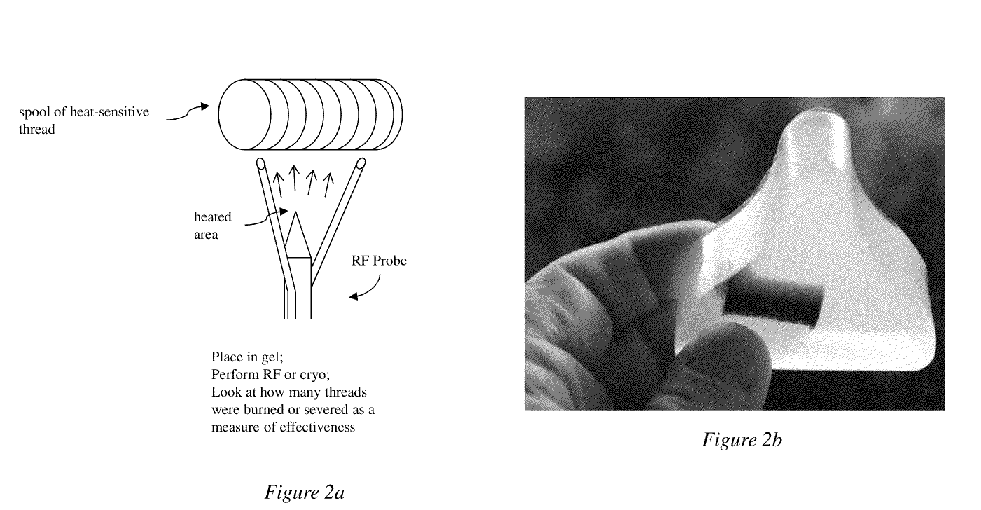

FIGS. 2a and 2b illustrate example representations of a physiological structure, a plurality of nerves, in gel (e.g., Agar), although other media is also possible, which can be used to gauge the application of heat and/or cold. The nerves are represented by heat-sensitive threads (e.g., configured to burn, sublime, change color, or otherwise be affected by temperature changes) spooled around a mandrel. Heat and/or cold can be applied, for example from a treatment device (e.g., the illustrated RF probe). The effect of the treatment device can be seen on the media and/or the nerves. For example, if heat from the treatment device is sufficient, the nerves may be ablated, allowing them to be counted and/or measure from the end of the spool, as a measure of effectiveness.

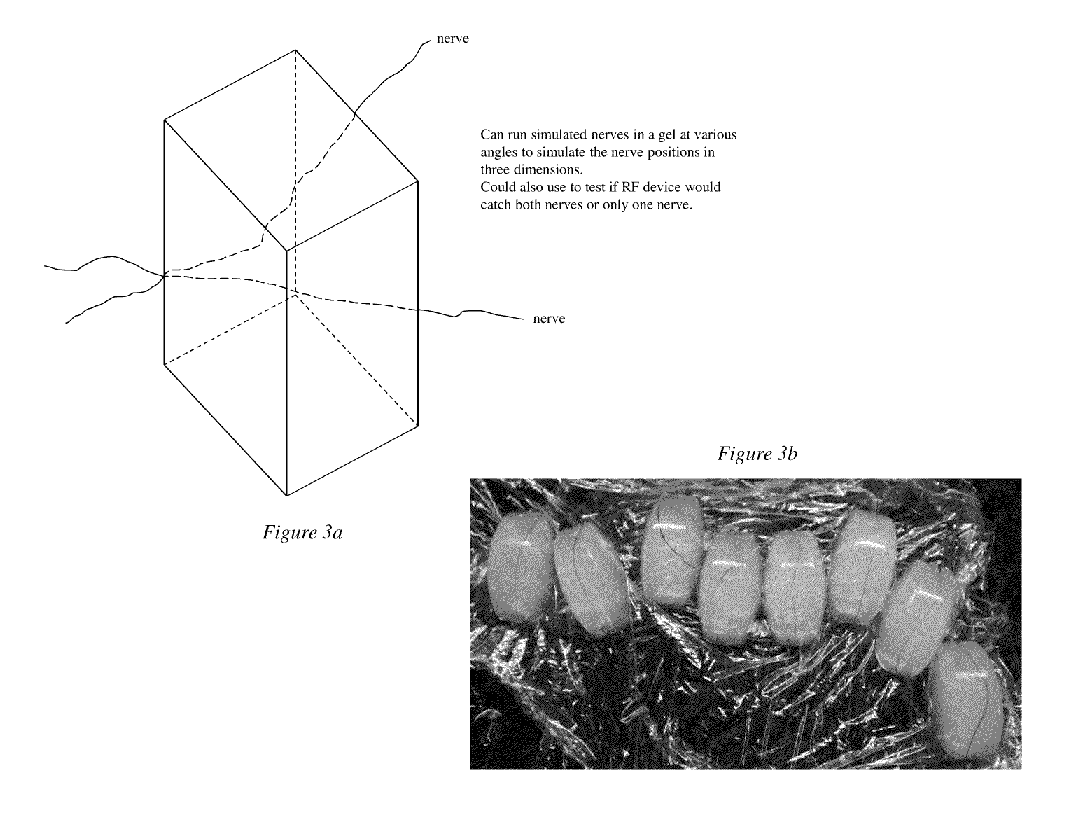

FIGS. 3a and 3b illustrate example representations of a physiological structure, two nerves, in gel (e.g., Agar), although other media is also possible, which can be used to gauge the application of heat and/or cold. The nerves may be represented by heat-sensitive threads (e.g., configured to burn, sublime, change color, or otherwise be affected by temperature changes). The nerves may be at various angles (e.g., entering and exiting the media at different sides and/or corners, for example to simulate nerve positions in three dimensions. Heat and/or cold can be applied, for example from a treatment device. The effect of the treatment device can be seen on the media and/or the nerves. For example, if heat from the treatment device is sufficient, the nerves may be ablated, allowing them to be pulled out of the media from either side, as a measure of effectiveness.

### Thermally Sensitive Substances

Application of thermal, color changing paint or other material to surfaces or models can illustrate heating or cooling effects of a heating device or a cooling device thereon.

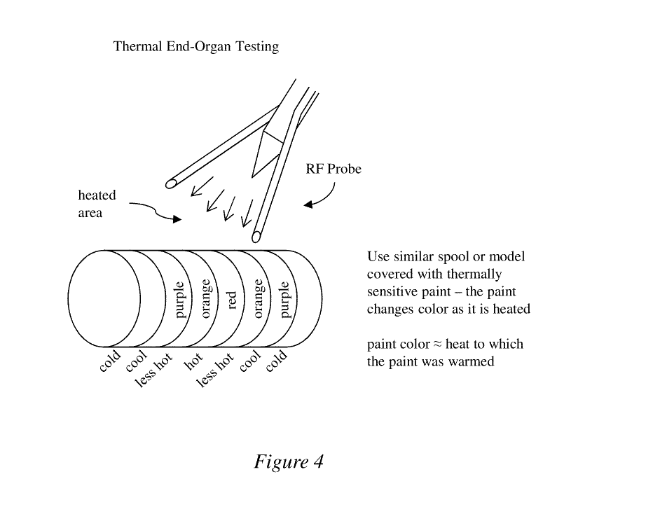

FIG. 4 illustrates an example representation of a physiological structure (e.g., a spool which may represent, for example, bone) in gel (e.g., Agar), although other media is also possible, which can be used to gauge the application of heat and/or cold. The spool is at least partially covered with thermally sensitive material (e.g., configured to burn, sublime, change color, or otherwise be affected by temperature changes). Heat and/or cold can be applied, for example from a treatment device (e.g., the illustrated RF probe). The effect of the treatment device can be seen on the media and/or the spool. For example, if heat from the treatment device is sufficient, the spool may change color, as a measure of effectiveness. For example, in the illustrated embodiments, the middle of the spool turned red, indicating the most heat, then proceeding outward, orange, indicating less heat, then purple, indicating even less heat or cool, and then no color, indicating cold. That is, material color may be used as an approximation of the amount of heat to which the material was subjected.

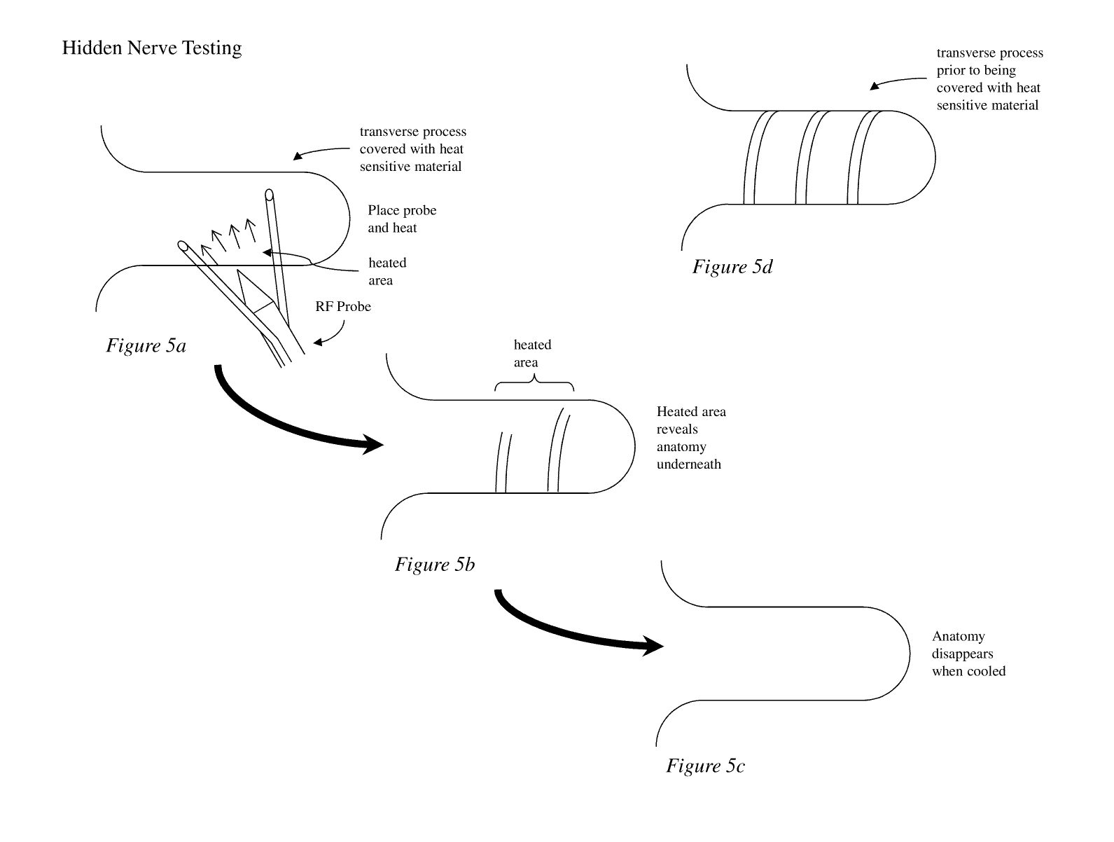

FIGS. 5a-5c illustrate an example representation of a physiological structure, a transverse process, in gel (e.g., Agar), although other media is also possible, which can be used to gauge the application of heat and/or cold. The transverse process is at least partially covered with thermally sensitive material (e.g., configured to burn, sublime, change color, or otherwise be affected by temperature changes). FIG. 5d shows the transverse process prior to being covered with the heat-sensitive material. Heat and/or cold can be applied, for example from a treatment device (e.g., the illustrated RF probe), for example as illustrated in FIG. 5a. The effect of the treatment device can be seen on the media and/or the spool, for example as illustrated in FIG. 5b. For example, if heat from the treatment device is sufficient, the spool may reveal model anatomy under the heat-sensitive material, as a measure of effectiveness. For example, as illustrated in FIG. 5b, portions of the four right nerves are revealed. That is, underlying anatomy visibility may be used as an approximation of the amount of heat to which the material was subjected. FIG. 5c illustrates that, upon cooling, the underlying anatomy may again disappear, or in some embodiments the effect on the heat-sensitive material may be substantially permanent or require some reversal process.

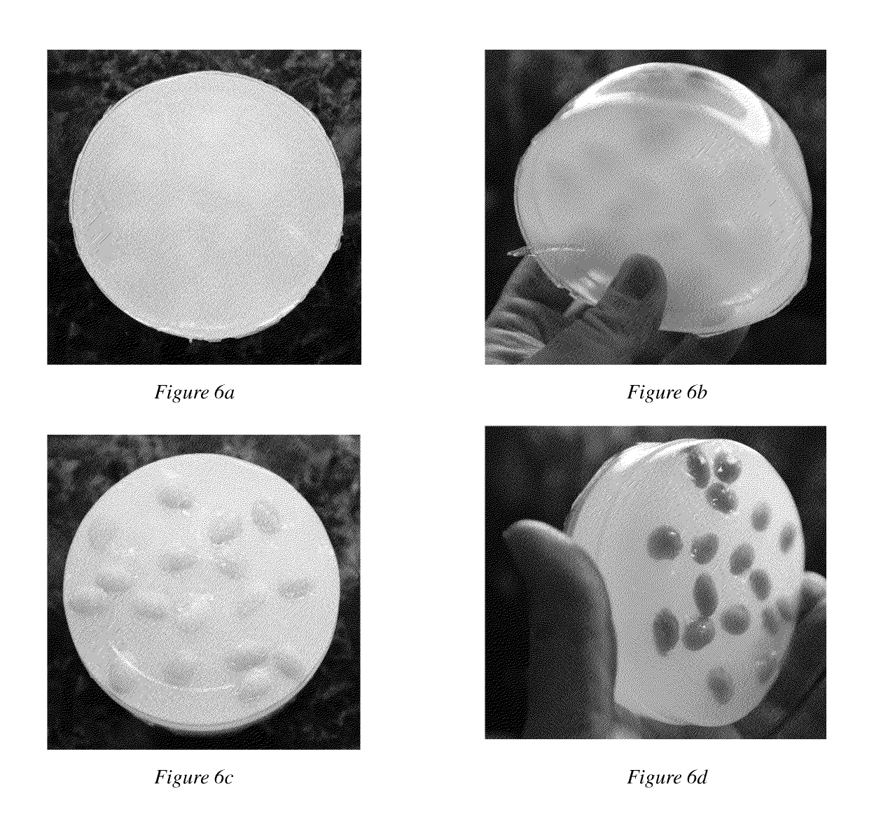

FIG. 6a illustrates an example representation, beads, of a physiological structure in gel (e.g., Agar), although other media is also possible, which can be used to gauge the application of heat and/or cold. FIG. 6b shows the structure of FIG. 6a being held as a representation of the general size. The beads are nearly at least partially covered with thermally sensitive material (e.g., configured to burn, sublime, change color, or otherwise be affected by temperature changes). In FIGS. 6c and 6d, the beads are nearly invisible. FIG. 6c illustrates the physiological structure of FIGS. 6a and 6b the application of heat and/or cold. In FIGS. 6c and 6d, the beads may change color, as a measure of effectiveness. For example, as illustrated in FIGS. 6c and 6d, some of the beads have changed to a very visible yellow-green.

### Media

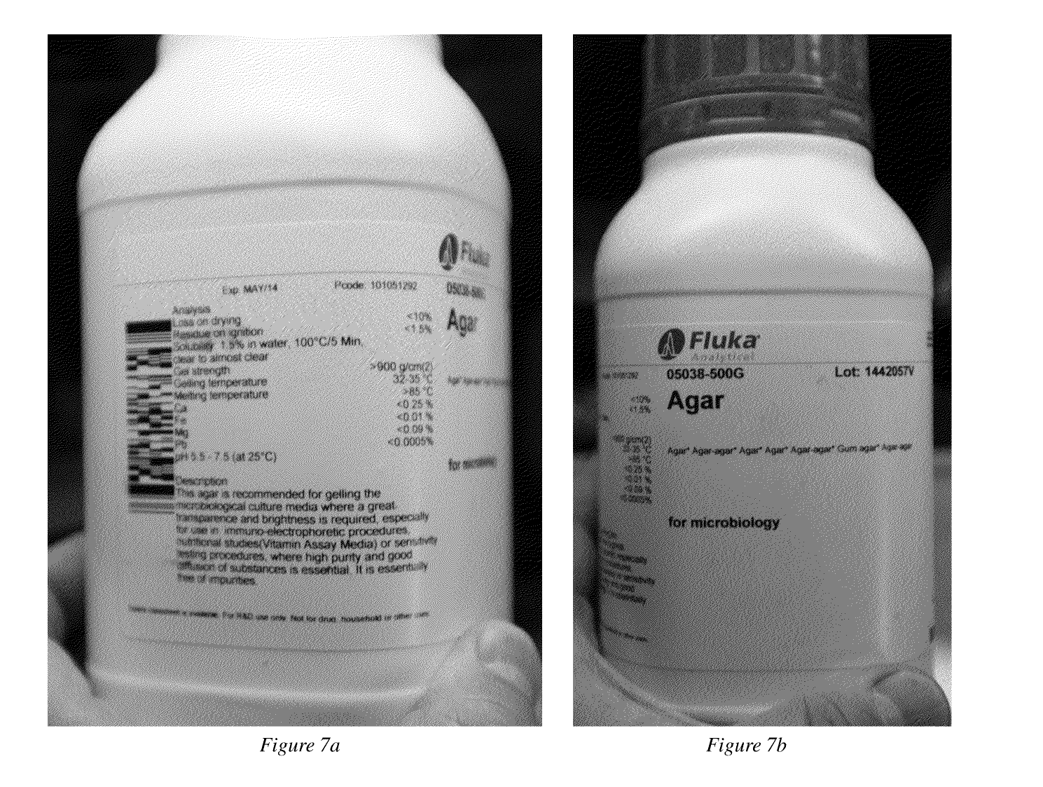

FIGS. 7a and 7b illustrate different sides of a bottle of an example source of media, agar, suitable for use in the representations of physiological structures described herein.

For clarity, FIG. 7a reads:

Exp: MAY/14 Pcode: 101051292
Analysis

| Loss on drying | <10% | |
|---|---|---|
| Residue on ignition | <1.5% | |
| Solubility: 1.5% in water, 100° C./5 Min. | | |
| clear to almost clear | | |
| Gel strength | >900 | g/cm(2) |
| Gelling temperature | 35-35° | C. |
| Melting temperature | >85° | C. |

| | |
|---|---|
| Ca | <0.25% |
| Fe | <0.01% |
| Mg | <0.09% |
| Pb | <0.0005% |
| pH 5.5-7.5 (at 25° C.) | |

### Description

This agar is recommended for telling the microbiological culture media where a great transparence and brightness is required, especially for use in immuno-electrophoretic procedures, nutritional studies (Vitamin Assay Media) or sensitivity testing procedures, where high purity and good diffusion of substances is essential. It is essentially free of impurities. Safety datasheet is available. For R&D use only. Not for drug, household or other uses.

For clarity, FIG. 7b reads:

| Fluka ® | |
|---|---|
| Analytical | |
| 05038-500G | Lot 1442057V |

Agar
Agar* Agar-agar* Agar* Agar* Agar-agar* Gum agar* Agar-agar
for microbiology

Other media may also be used depending on the application.

What is claimed is:

1. A structure comprising:
a substance; and
a plurality of conducting wires connected to a meter, the plurality of conducting wires immersed in the substance.
